(19) United States
(12) Patent Application Publication
(10) Pub. No.: US 2005/0008478 A1
(43) Pub. Date: Jan. 13, 2005

(54) Outlet airflow direction control device

(75) Inventors: Bor-Haw Chang, Taipei Hsien (TW); Wen-Hao Liu, Taipei Hsien (TW)

Correspondence Address: BACON & THOMAS, PLLC, 625 SLATERS LANE, FOURTH FLOOR, ALEXANDRIA, VA, 22314, US

(73) Assignee: ASIA VITAL COMPONENTS CO., LTD., Kaohsiung (TW)

(21) Appl. No.: 10/615,233

(22) Filed: Jul. 9, 2003

(51) Int. Cl. F03B 1/04

(52) U.S. Cl. 415/149.2

(57) ABSTRACT

An outlet airflow direction control device mainly includes a frame and a fan. The frame has an inlet and an outlet via which an amount of fluid flows into and out of the frame, and is internally provided at a predetermined position with a hub seat. The hub seat is provided on a peripheral wall with a plurality of radially projected fluid control elements. The fan is mounted on the hub seat in the frame. When the fan is rotated to cause an amount of fluid to flow through the outlet of the frame, the fluid control elements are adapted to control a flow direction of the fluid flown out of the outlet.

### FIELD OF THE INVENTION

The present invention relates to an outlet airflow direction control device including a frame and a fan. The frame has an inlet and an outlet and is internally provided with a hub seat. The hub seat is provided on a peripheral wall with a plurality of radially projected fluid control elements, and the fan is mounted on the hub seat in the frame.

### BACKGROUND OF THE INVENTION

Most currently developed electronic products have powerful functions and constantly increased working frequency and operating speed. The higher the working frequency is, the more heat is produced during the operation of the electronic products. The electronic products tend to become unstable when they operate under a high-temperature state. Therefore, it has become an important issue to effectively and quickly remove waste heat from the electronic products to reduce an internal temperature thereof, enabling the electronic products to operate under an optimal working temperature. The use of a fan is one of many economical ways to effectively remove heat from the operating electronic products. When a motor of the fan is actuated to rotate blades of the fan, electric energy is converted into mechanical energy, which is transferred via the blades to cause flowing of a fluid and increasing a coefficient of convection in a limited space, so that flowing of fluid produced by changes in pressure and increase of speed is used to carry away extra heat produced by the electronic products during operation thereof and achieve the purpose of dissipating heat.

Generally, when an amount of fluid is driven by the rotating blades of the fan to flow through an outlet of the fan, the fluid only diffuses into outer areas surrounding the fan. Since the fan is not able to control the flow direction of the fluid, a relatively large dead-air zone is formed behind a hub of the fan to largely reduce the radiation effect that may be achieved by the fan.

Taiwanese Invention Patent Application No. 090118816 entitled “Sectional Fan and a Fan Frame Thereof” discloses a sectional fan that includes a fan and a fan frame. The fan frame further includes a first frame and a first flow-guiding element provided in the first frame. The first flow-guiding element includes a plurality of radially extended stationary blades. When the fan is rotated, the stationary blades are adapted to enhance the volume and pressure of airflow produced by the fan.

With the above-mentioned sectional fan, it is unable to control the direction in which the fluid flown out of the rotating fan, just as most conventional fans. Thus, the sectional fan has only limited control ability in heat dissipating and fails to effectively solve the problem of radiating encountered by most electronic products.

It is therefore tried by the inventor to develop an outlet airflow direction control device to eliminate drawbacks existed in the conventional radiating fans.

### SUMMARY OF THE INVENTION

A primary object of the present invention is to provide an outlet airflow direction control device that uses radially projected fluid control elements to produce a relative large radial pressure against the fluid flown through the device, so as to affect the flow direction of the fluid.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front exploded perspective view of an outlet airflow direction control device according to a first embodiment of the present invention;

FIG. 2 is a front view of a frame of the outlet airflow direction control device of FIG. 1;

FIG. 3 is a front assembled perspective view of the outlet airflow direction control device of FIG. 1;

FIG. 4 is a cross sectional view of the outlet airflow direction control device of FIG. 1 showing airflow directions at an outlet of the device;

FIG. 5 shows a variant of the control blade included in the first embodiment of the present invention;

FIG. 6 shows another variant of the control blade included in the first embodiment of the present invention;

FIG. 7 shows a further variant of the control blade included in the first embodiment of the present invention;

FIG. 8 is a front exploded perspective view of an outlet airflow direction control device according to a second embodiment of the present invention;

FIG. 9 is a front view of a frame of the outlet airflow direction control device of FIG. 8;

FIG. 10 is a front assembled perspective view of the outlet airflow direction control device of FIG. 8;

FIG. 11 is a cross sectional view of the outlet airflow direction control device of FIG. 8 showing airflow directions at an outlet of the device;

FIG. 12 is a front exploded perspective view of an outlet airflow direction control device according to a third embodiment of the present invention;

FIG. 13 is a front view of a frame of the outlet airflow direction control device of FIG. 12;

FIG. 14 is a front assembled perspective view of the outlet airflow direction control device of FIG. 12;

FIG. 15 is a cross sectional view of the outlet airflow direction control device of FIG. 12 showing airflow directions at an outlet of the device;

FIG. 16 shows a variant of the control blade included in the third embodiment of the present invention;

FIG. 17 shows another variant of the control blade included in the third embodiment of the present invention;

FIG. 18 shows a further variant of the control blade included in the third embodiment of the present invention;

FIG. 19 is a front exploded perspective view of an outlet airflow direction control device according to a fourth embodiment of the present invention;

FIG. 20 is a front view of a frame of the outlet airflow direction control device of FIG. 19;

FIG. 21 is a front assembled perspective view of the outlet airflow direction control device of FIG. 19;

FIG. 22 is a cross sectional view of the outlet airflow direction control device of FIG. 19 showing airflow directions at an outlet of the device;

FIG. 23 is a front exploded perspective view of an outlet airflow direction control device according to a fifth embodiment of the present invention;

FIG. 24 is a front view of a frame of the outlet airflow direction control device of FIG. 23;

FIG. 25 is a front assembled perspective view of the outlet airflow direction control device of FIG. 23;

FIG. 26 is a cross sectional view of the outlet airflow direction control device of FIG. 23 showing airflow directions at an outlet of the device;

FIG. 27 shows a variant of the control blade included in the fifth embodiment of the present invention;

FIG. 28 shows another variant of the control blade included in the fifth embodiment of the present invention;

FIG. 29 shows a further variant of the control blade included in the fifth embodiment of the present invention;

FIG. 30 is a front exploded perspective view of an outlet airflow direction control device according to a sixth embodiment of the present invention;

FIG. 31 is a front view of a frame of the outlet airflow direction control device of FIG. 30;

FIG. 32 is a front assembled perspective view of the outlet airflow direction control device of FIG. 30;

FIG. 33 is a cross sectional view of the outlet airflow direction control device of FIG. 30 showing airflow directions at an outlet of the device;

FIG. 34 is a front exploded perspective view of an outlet airflow direction control device according to a seventh embodiment of the present invention;

FIG. 35 is a front view of a frame of the outlet airflow direction control device of FIG. 34;

FIG. 36 is a front assembled perspective view of the outlet airflow direction control device of FIG. 34;

FIG. 37 is a cross sectional view of the outlet airflow direction control device of FIG. 34 showing airflow directions at an outlet of the device;

FIG. 38 shows a variant of the control blade included in the seventh embodiment of the present invention;

FIG. 39 shows another variant of the control blade included in the seventh embodiment of the present invention;

FIG. 40 shows a further variant of the control blade included in the seventh embodiment of the present invention;

FIG. 41 is a front exploded perspective view of an outlet airflow direction control device according to an eighth embodiment of the present invention;

FIG. 42 is a front view of a frame of the outlet airflow direction control device of FIG. 41;

FIG. 43 is a front assembled perspective view of the outlet airflow direction control device of FIG. 41;

FIG. 44 is a cross sectional view of the outlet airflow direction control device of FIG. 41 showing airflow directions at an outlet of the device;

FIG. 45 is a front exploded perspective view of an outlet airflow direction control device according to a ninth embodiment of the present invention;

FIG. 46 is a front view of a frame of the outlet airflow direction control device of FIG. 45;

FIG. 47 is a front assembled perspective view of the outlet airflow direction control device of FIG. 45;

FIG. 48 is a cross sectional view of the outlet airflow direction control device of FIG. 45 showing airflow directions at an outlet of the device;

FIG. 49 shows a variant of the control blade included in the ninth embodiment of the present invention;

FIG. 50 shows another variant of the control blade included in the ninth embodiment of the present invention;

FIG. 51 shows a further variant of the control blade included in the ninth embodiment of the present invention;

FIG. 52 is a front exploded perspective view of an outlet airflow direction control device according to a tenth embodiment of the present invention;

FIG. 53 is a front view of a frame of the outlet airflow direction control device of FIG. 52;

FIG. 54 is a front assembled perspective view of the outlet airflow direction control device of FIG. 52;

FIG. 55 is a cross sectional view of the outlet airflow direction control device of FIG. 52 showing airflow directions at an outlet of the device;

FIG. 56 is a front exploded perspective view of an outlet airflow direction control device according to an eleventh embodiment of the present invention;

FIG. 57 is a front view of a frame of the outlet airflow direction control device of FIG. 56;

FIG. 58 is a front assembled perspective view of the outlet airflow direction control device of FIG. 56;

FIG. 59 is a cross sectional view of the outlet airflow direction control device of FIG. 56 showing airflow directions at an outlet of the device;

FIG. 60 shows a variant of the control blade included in the eleventh embodiment of the present invention;

FIG. 61 shows another variant of the control blade included in the eleventh embodiment of the present invention;

FIG. 62 shows a further variant of the control blade included in the eleventh embodiment of the present invention;

FIG. 63 is a front exploded perspective view of an outlet airflow direction control device according to a twelfth embodiment of the present invention;

FIG. 64 is a front view of a frame of the outlet airflow direction control device of FIG. 63;

FIG. 65 is a front assembled perspective view of the outlet airflow direction control device of FIG. 63; and

FIG. 66 is a cross sectional view of the outlet airflow direction control device of FIG. 63 showing airflow directions at an outlet of the device.

### DETAILED DESCRIPTION OF THE PREFERRED EMBODIMENTS

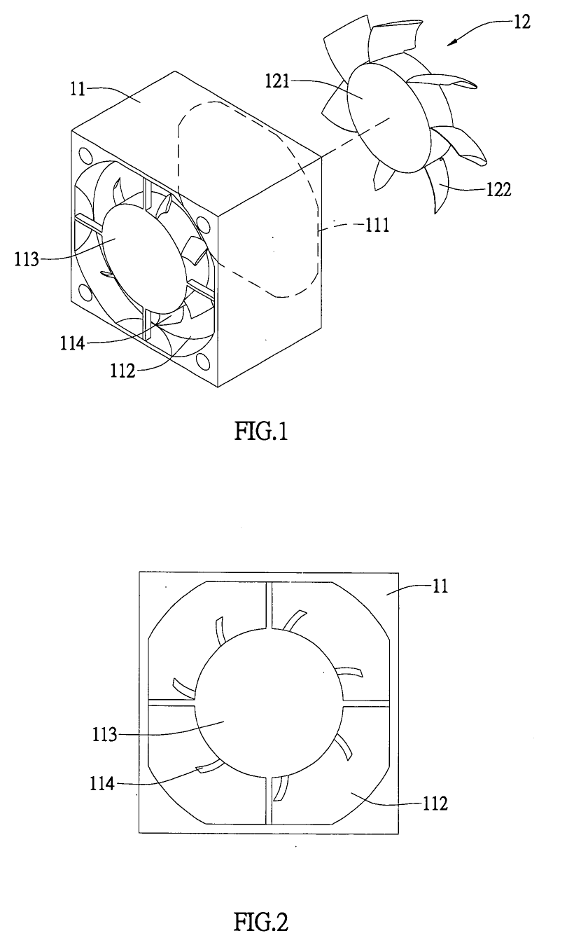

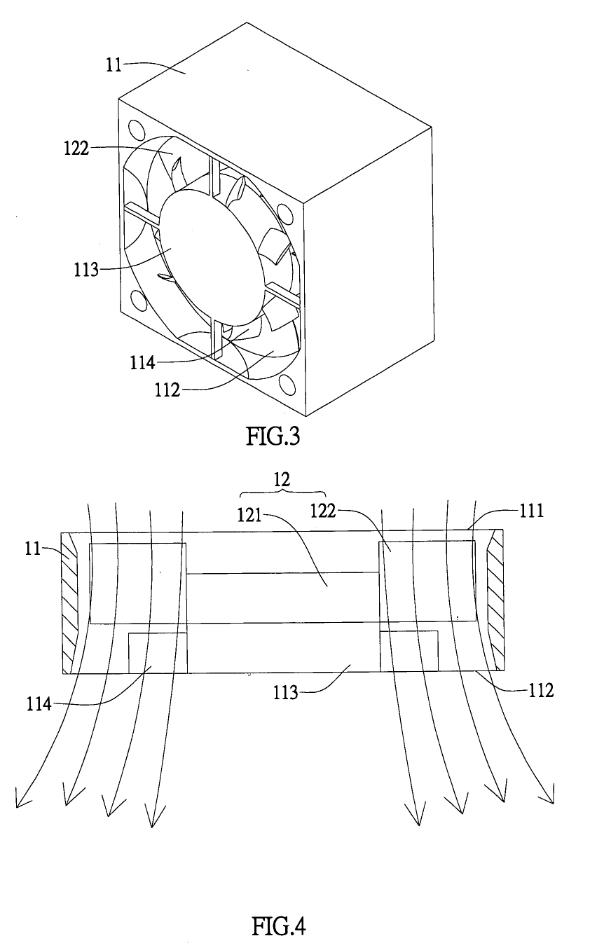

Please refer to FIGS. 1, 2, and 3, in which an outlet airflow direction control device according to a first embodiment of the present invention is shown. As shown, the outlet airflow direction control device mainly includes a frame 11 and a fan 12. The fan 12 includes a hub 121 and a plurality of blades 122. The frame 11 includes an inlet 111 and an outlet 112 via which an amount of fluid flows into and out of the frame 11. The frame 11 is also internally provided with a hub seat 113 to support the fan 12 thereon. The hub seat 113 at the outlet 112 of the frame 11 is formed on an outer circumferential surface with a plurality of radially projected control blades 114 adapted to change a radial pressure against the fluid flowing through the frame 11. Therefore, directions in which the fluid flows may be controlled.

Please refer to FIG. 4. When the blades 122 of the fan 12 are rotated, a non-constant flow field is produced to cause the fluid to flow into the frame 11 via the inlet 111 and out of the frame 11 via the outlet 112. When the fluid flows through the outlet 112, it is affected by the radially projected control blades 114 and is subject to a relatively large radial pressure, enabling the fluid to diffuse outward into an enlarged space.

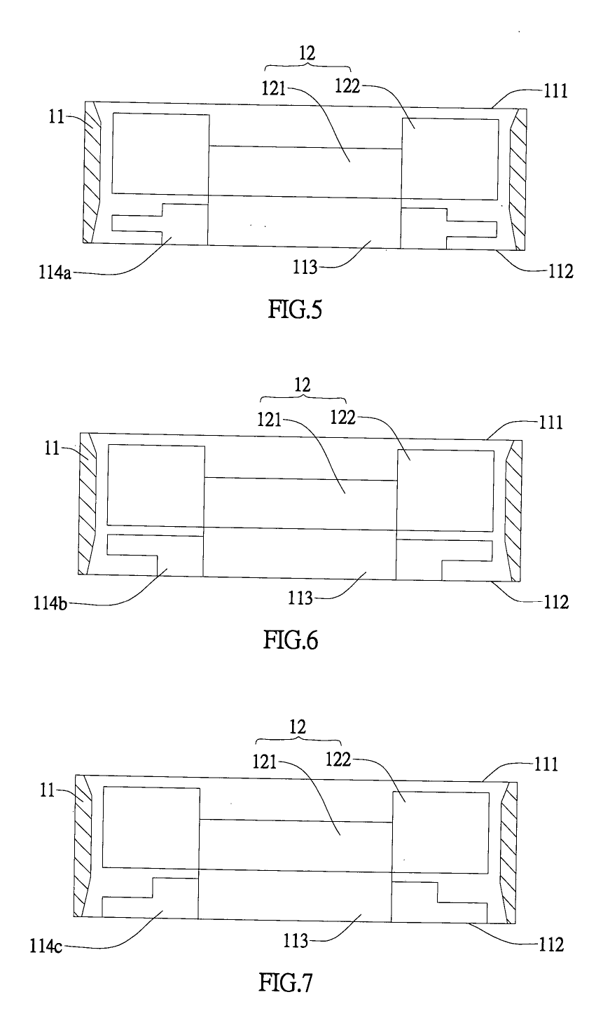

Please refer to FIGS. 4, 5, 6, and 7. The control blade 114 for the present invention may be differently configured, such as T-shaped, reverse L-shaped, and L-shaped control blade 114a, 114b, and 114c, as shown in FIGS. 5, 6, and 7, respectively. All the above three types of control blades are adapted to change the radial pressure against the fluid passing through the outlet 112 to achieve the effect of controlling the flow direction of the fluid.

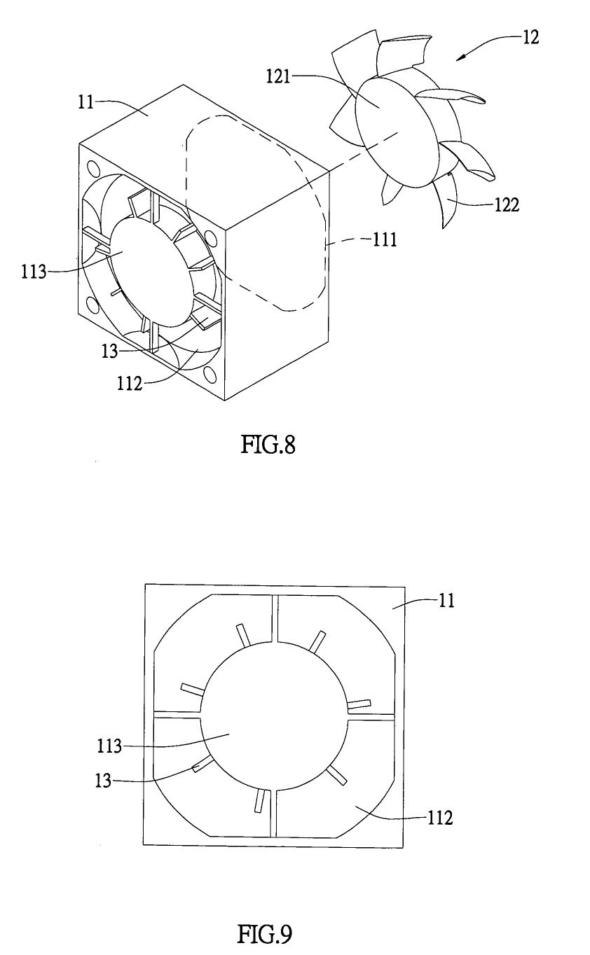

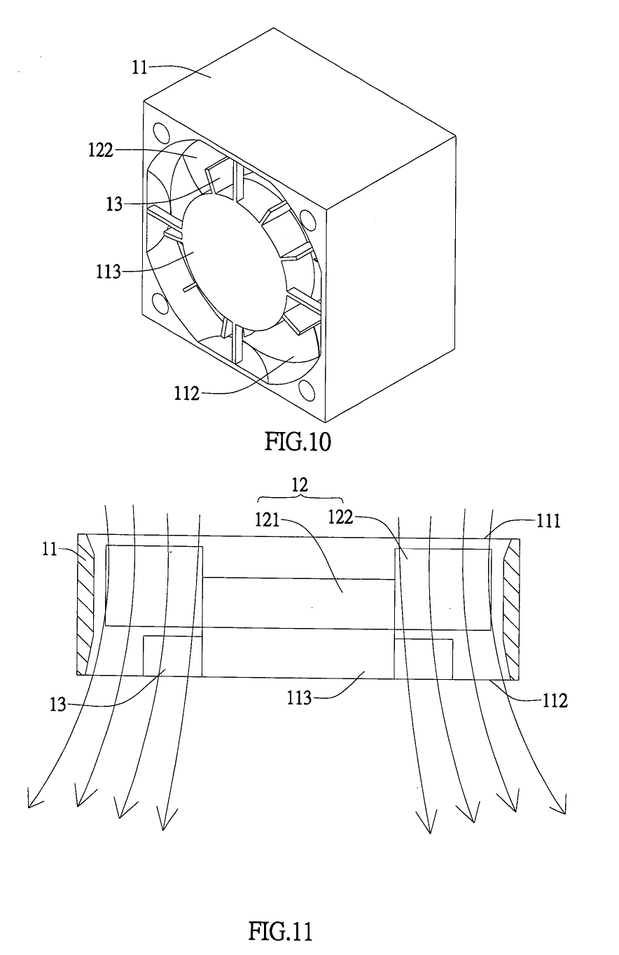

Please refer to FIGS. 8 to 11 in which an outlet airflow direction control device according to a second embodiment of the present invention is shown. As shown, the second embodiment is structurally and functionally similar to the first embodiment, except that the hub seat 113 at the outlet 112 of the frame 11 of the second embodiment is formed on a peripheral wall thereof with a plurality of radially projected ribs 13 to change the radial pressure against the fluid flowing through the frame 11 and thereby control the flow direction of the fluid at the outlet 112.

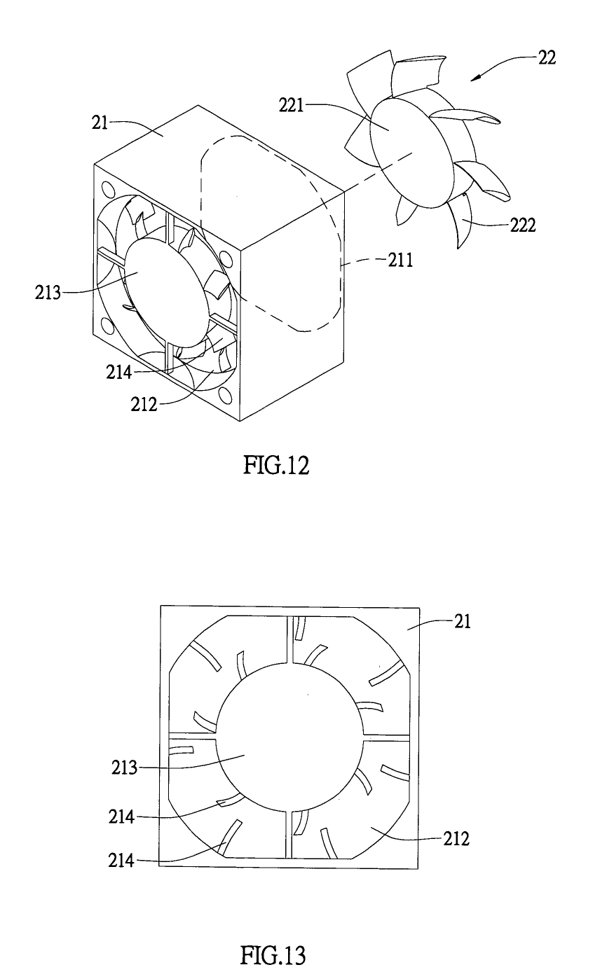

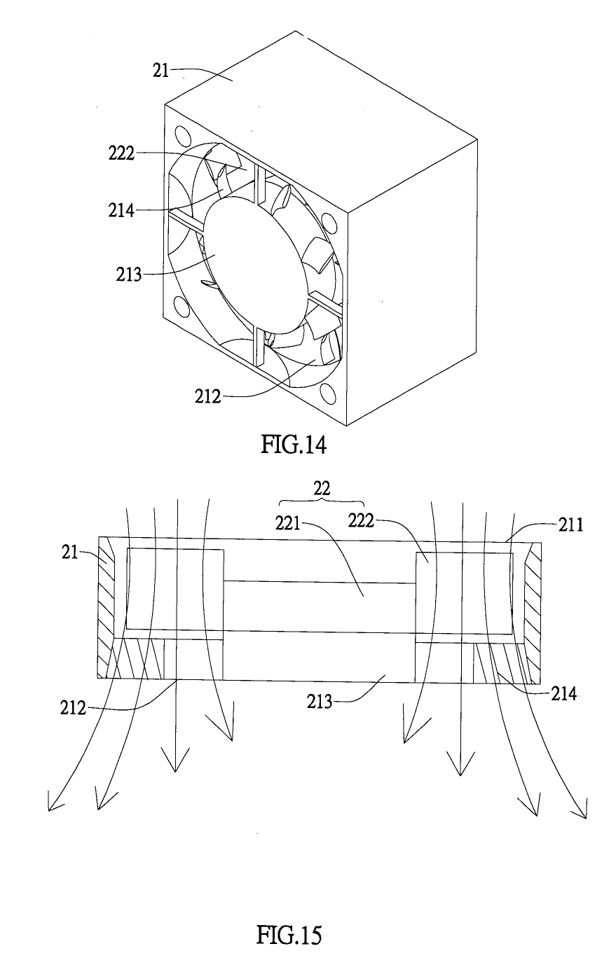

Please refer to FIGS. 12, 13, and 14 in which an outlet airflow direction control device according to a third embodiment of the present invention is shown. As shown, the outlet airflow direction control device according to the third embodiment mainly includes a frame 21 and a fan 22. The fan 22 includes a hub 221 and a plurality of blades 222. The frame 21 includes an inlet 211 and an outlet 212 via which an amount of fluid flows into and out of the frame 21. The frame 21 is internally provided with a hub seat 213 to support the fan 22 thereon. Both the outlet 212 of the frame 21 and the hub seat 213 at the outlet 212 of the frame 21 are formed on respective peripheral wall with a plurality of radially projected control blades 214 adapted to change a radial pressure against the fluid flowing through the frame 21, and thereby control the flow direction of the fluid at the outlet 212.

Please refer to FIG. 15. When the blades 222 of the fan 22 are rotated, a non-constant flow field is produced to cause the fluid to flow into the frame 21 via the inlet 211 and out of the frame 21 via the outlet 212. When the fluid flows through the outlet 212, it is affected by the radially projected control blades 214 and is subject to a relatively large radial pressure to therefore flow toward a central area behind the hub seat 213 and diffuse into surrounding space. And, when the fluid flows to the back of the hub seat 213, a dead-air zone behind the hub seat 213 is reduced. Therefore, when the outlet airflow direction control device according to the third embodiment of the present invention is used to carry heat produced in a system to external environments, it provides largely upgraded radiation efficiency to achieve an enhanced overall radiation effect.

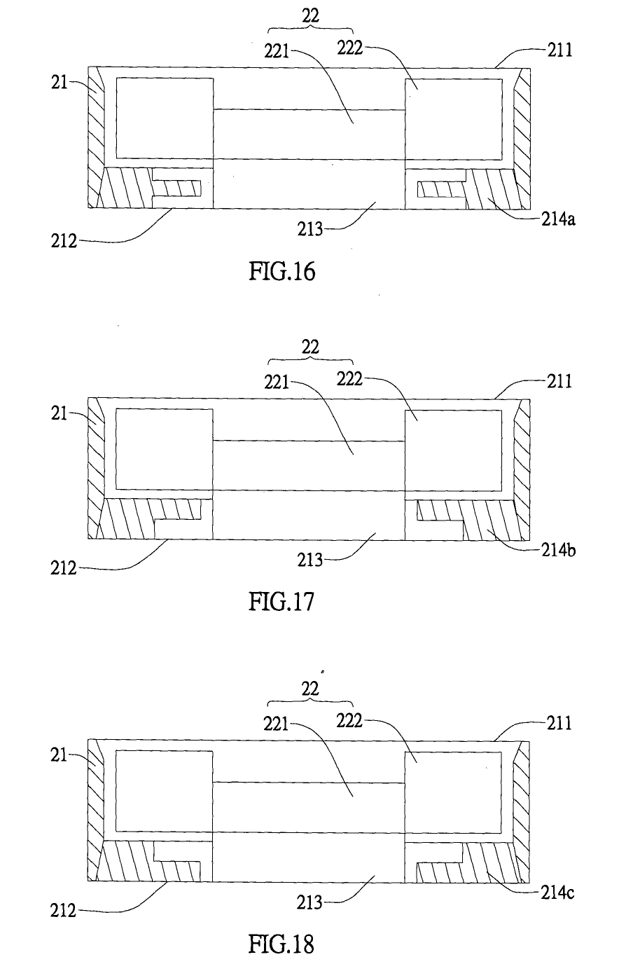

Please refer to FIGS. 15, 16, 17, and 18. The control blade 214 for the present invention may be differently configured, such as T-shaped, reverse L-shaped, and L-shaped control blade 214a, 214b, and 214c, as shown in FIGS. 16, 17, and 18, respectively. All the above three types of control blades are adapted to change the radial pressure against the fluid passing through the outlet 212 to achieve the effect of controlling the flow direction of the fluid and producing enhanced radiating power.

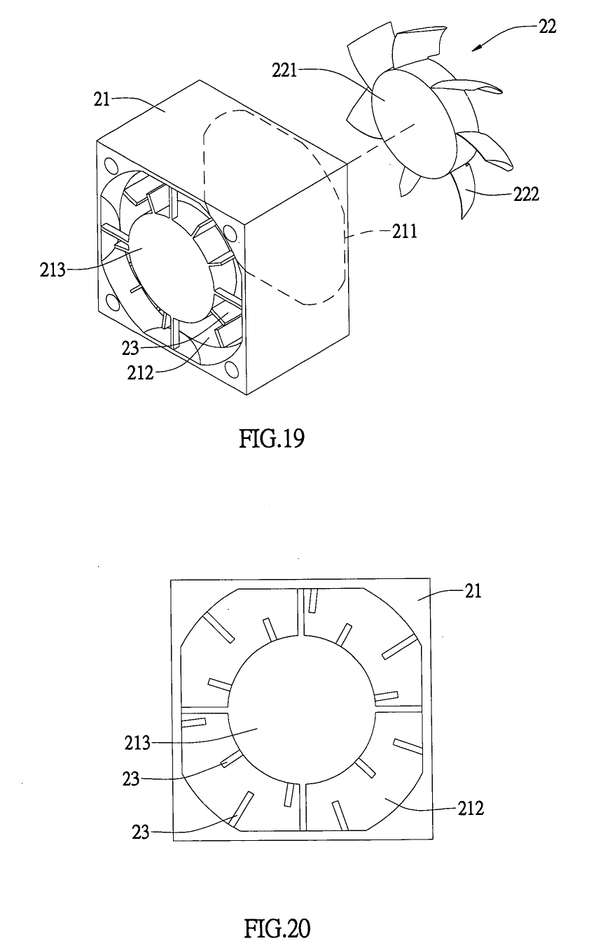

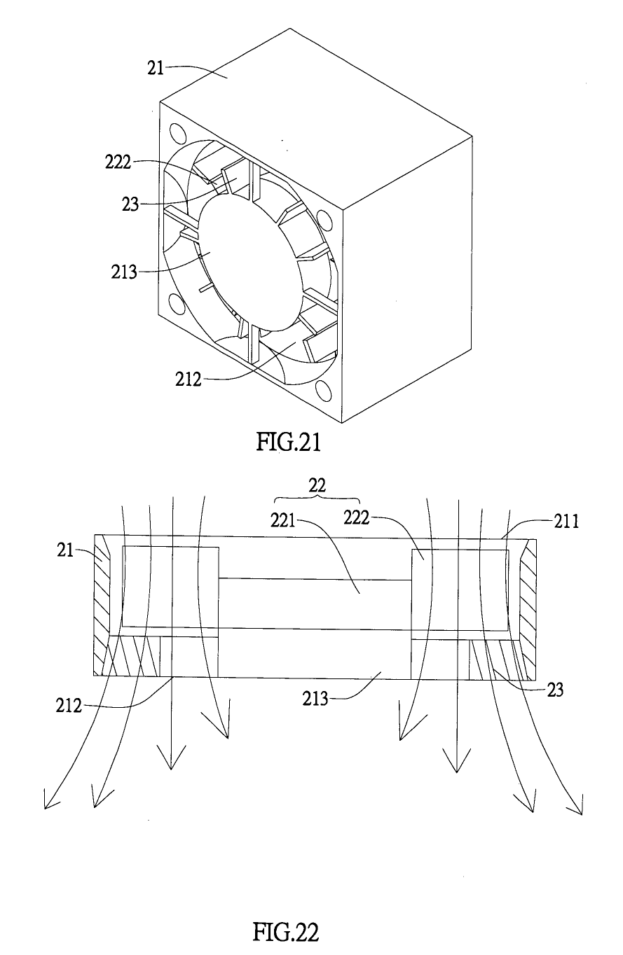

Please now refer to FIGS. 19, 20, 21, and 22, in which an outlet airflow direction control device according to a fourth embodiment of the present invention is shown. As shown, the fourth embodiment is structurally and functionally similar to the third embodiment, except that both the outlet 212 of the frame 21 and the hub seat 213 of the fourth embodiment is formed on respective peripheral wall with a plurality of radially projected ribs 23 to change the radial pressure against the fluid flowing through the frame 21 and thereby control the flow direction of the fluid at the outlet 212.

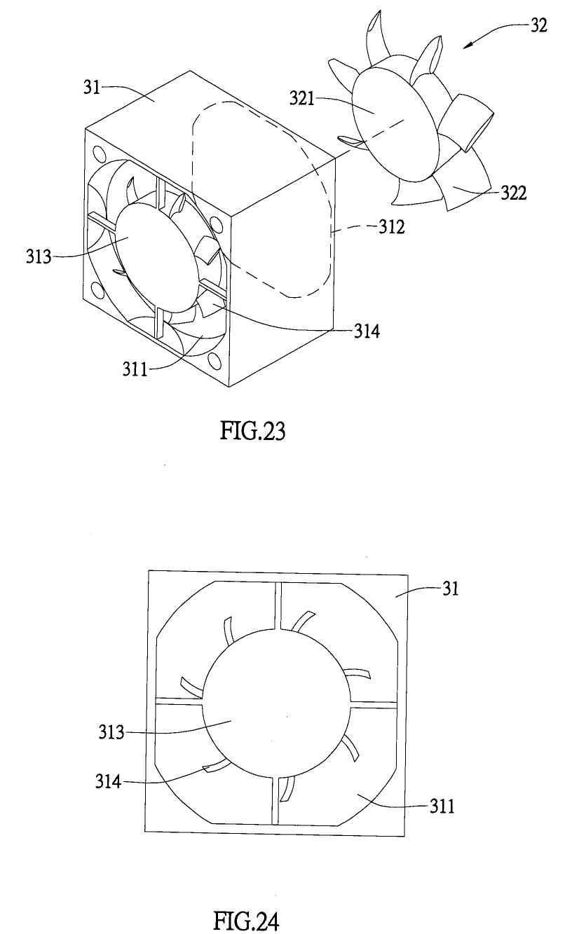

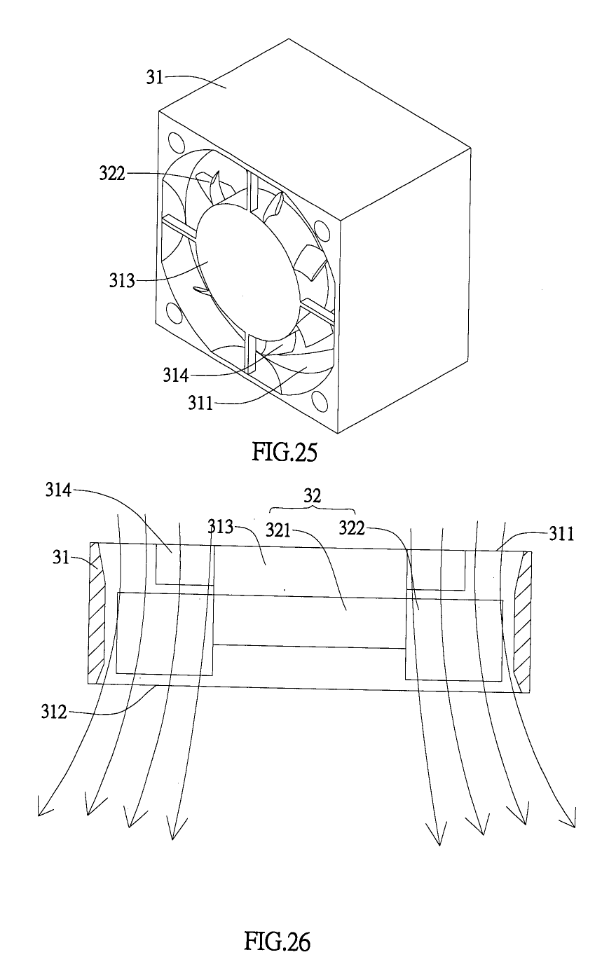

Please refer to FIGS. 23, 24, and 25 in which an outlet airflow direction control device according to a fifth embodiment of the present invention is shown. As shown, the outlet airflow direction control device according to the fifth embodiment mainly includes a frame 31 and a fan 32. The fan 32 includes a hub 321 and a plurality of blades 322. The frame 31 includes an inlet 311 and an outlet 312 via which an amount of fluid flows into and out of the frame 31. The frame 31 is internally provided with a hub seat 313 to support the fan 32 thereon. The hub seat 313 at the inlet 311 of the frame 31 is formed on an outer peripheral wall with a plurality of radially projected control blades 314 adapted to change a radial pressure against the fluid flowing through the frame 31, and thereby control the flow direction of the fluid.

Please refer to FIG. 26. When the blades 322 of the fan 32 are rotated, anon-constant flow field is produced to cause the fluid to flow into the frame 31 via the inlet 311 and out of the frame 31 via the outlet 312. When the fluid flows through the inlet 311, it is affected by the radially projected control blades 314 and is subject to a relatively large radial pressure to therefore concentrate at free ends of the blades 322. And, when the blades 322 are rotated to cause the fluid to flow through the outlet 312 of the frame 31, the fluid diffuse into surrounding space. Since the fluid is subject to an increased radial pressure, it diffuses into an even increased space.

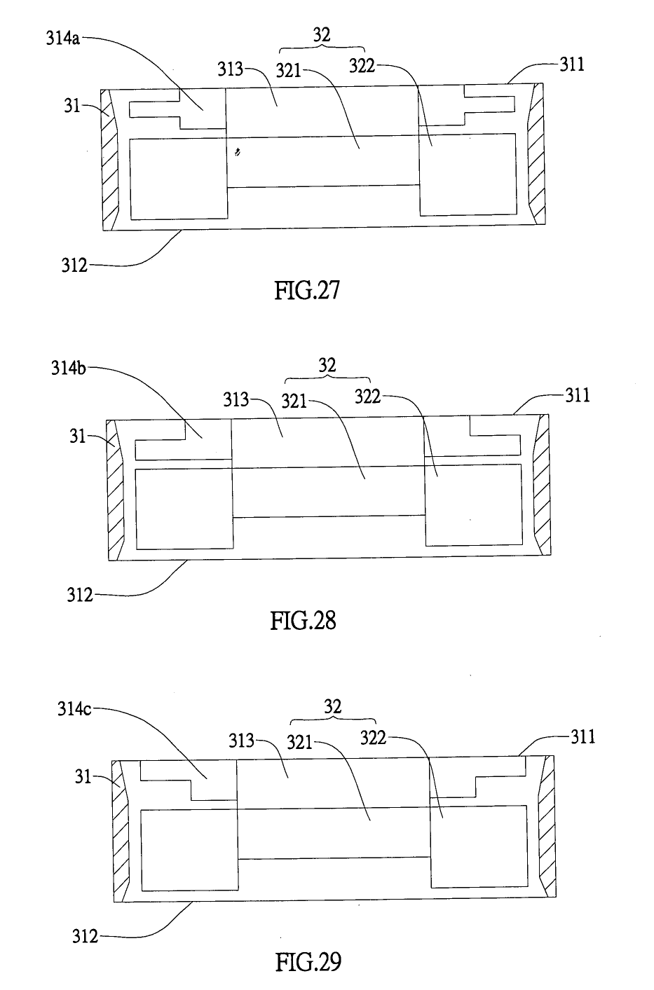

Please refer to FIGS. 26, 27, 28, and 29. The control blade 314 for the present invention may be differently configured, such as T-shaped, reverse L-shaped, and L-shaped control blade 314a, 314b, and 314c, as shown in FIGS. 27, 28, and 29, respectively. All the above three types of control blades are adapted to change the radial pressure against the fluid passing through the outlet 312 to achieve the effect of controlling the flow direction of the fluid.

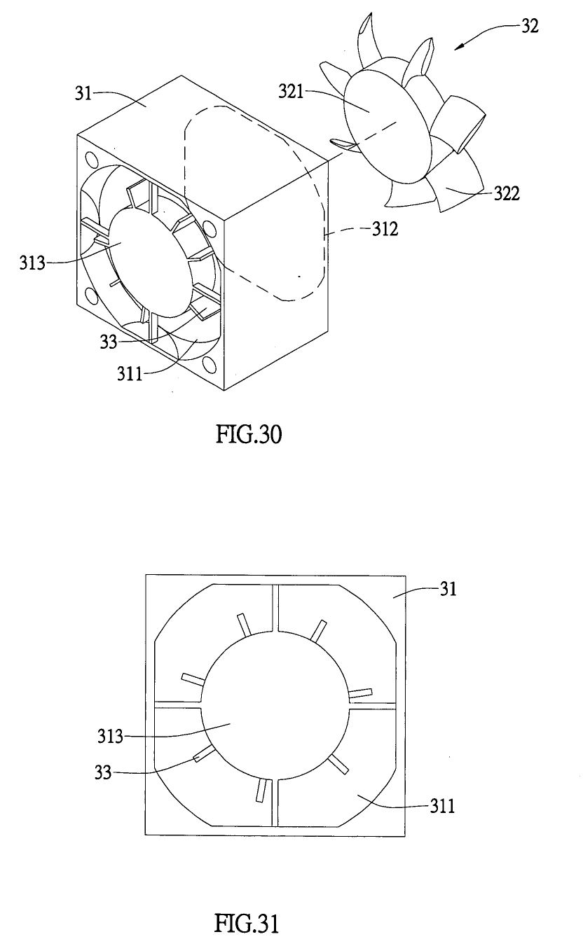

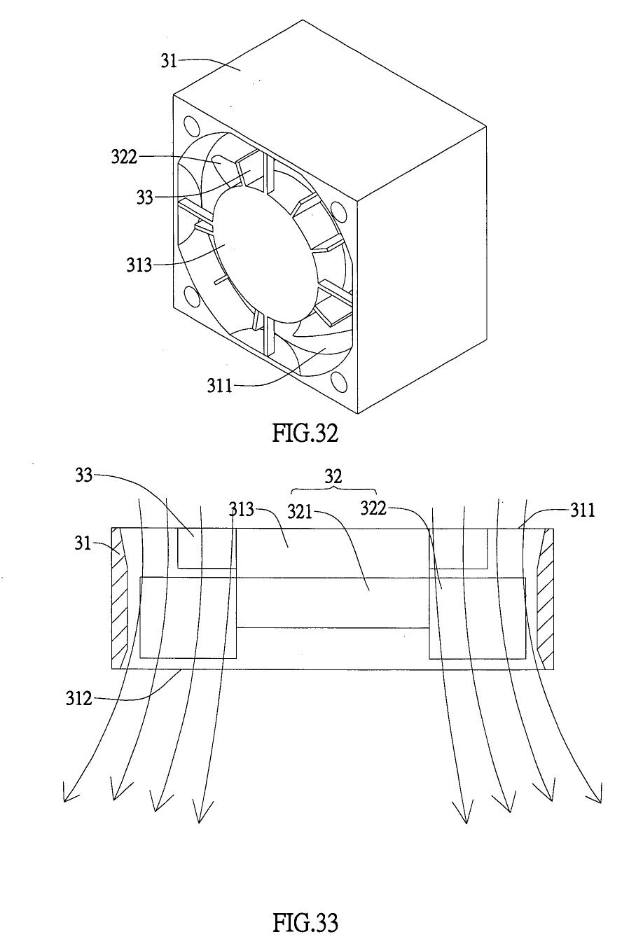

Please now refer to FIGS. 30, 31, 32, and 33, in which an outlet airflow direction control device according to a sixth embodiment of the present invention is shown. As shown, the sixth embodiment is structurally and functionally similar to the fifth embodiment, except that the hub seat 313 at the inlet 311 of the frame 31 of the sixth embodiment is formed on an outer peripheral wall with a plurality of radially projected ribs 33 to change the radial pressure against the fluid flowing through the frame 31 and thereby control the flow direction of the fluid.

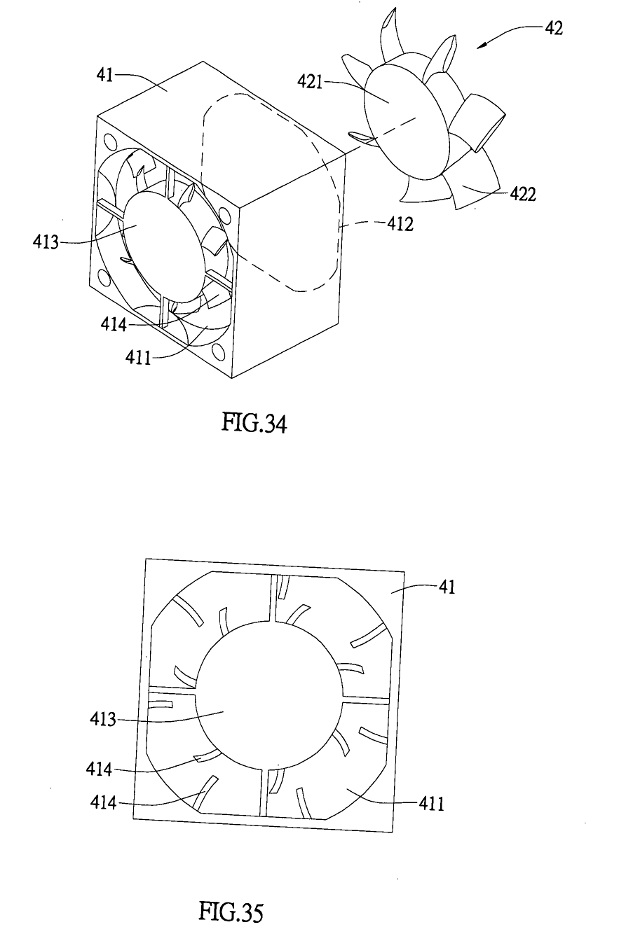

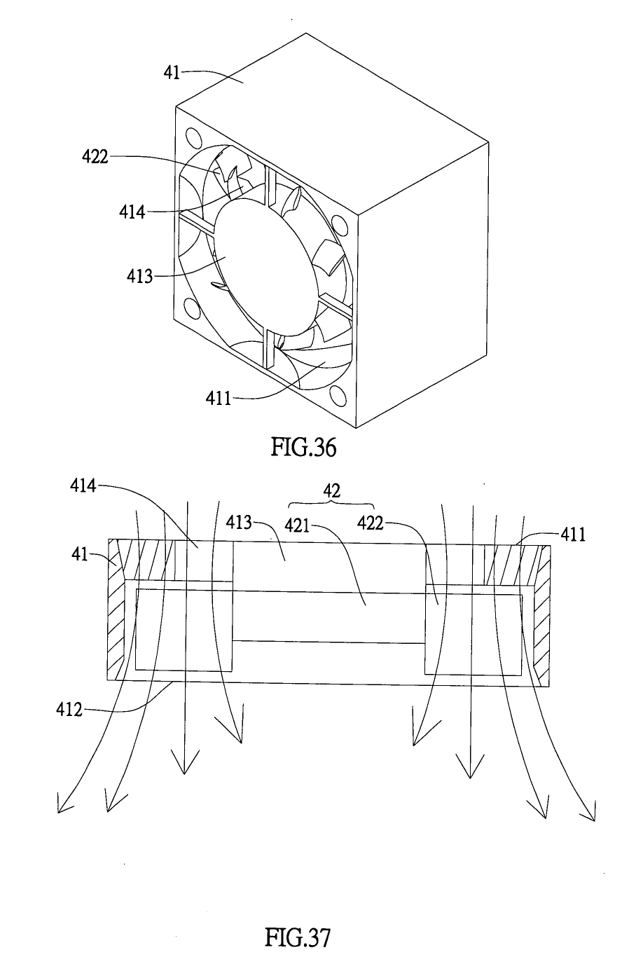

Please refer to FIGS. 34, 35, and 36, in which an outlet airflow direction control device according to a seventh embodiment of the present invention is shown. As shown, the outlet airflow direction control device according to the seventh embodiment mainly includes a frame 41 and a fan 42. The fan 42 includes a hub 421 and a plurality of blades 422. The frame 41 includes an inlet 411 and an outlet 412 via which an amount of fluid flows into and out of the frame 41. The frame 41 is internally provided with a hub seat 413 to support the fan 42 thereon. Both the inlet 411 of the frame 41 and the hub seat 413 at the inlet 411 of the frame 41 are formed on respective peripheral wall with a plurality of radially projected control blades 414 adapted to change a radial pressure against the fluid flowing through the frame 41, and thereby control the flow direction of the fluid.

Please refer to FIG. 37. When the blades 422 of the fan 42 are rotated, a non-constant flow field is produced to cause the fluid to flow into the frame 41 via the inlet 411 and out of the frame 41 via the outlet 412. When the fluid flows through the inlet 411, it is affected by the radially projected control blades 414 and is subject to a relatively large radial pressure to therefore concentrate at the hub 421 and free ends of the blades 422. And, when the blades 422 are rotated to cause the fluid to flow through the outlet 412 of the frame 41, the fluid flows toward a central area behind the hub 421 and diffuses into surrounding space. And, when the fluid flows to the back of the hub 421, a dead-air zone behind the hub 421 is reduced. Therefore, when the outlet airflow direction control device according to the seventh embodiment of the present invention is used to carry heat produced in a system to external environments, it provides largely upgraded radiation efficiency to achieve an enhanced overall radiation effect.

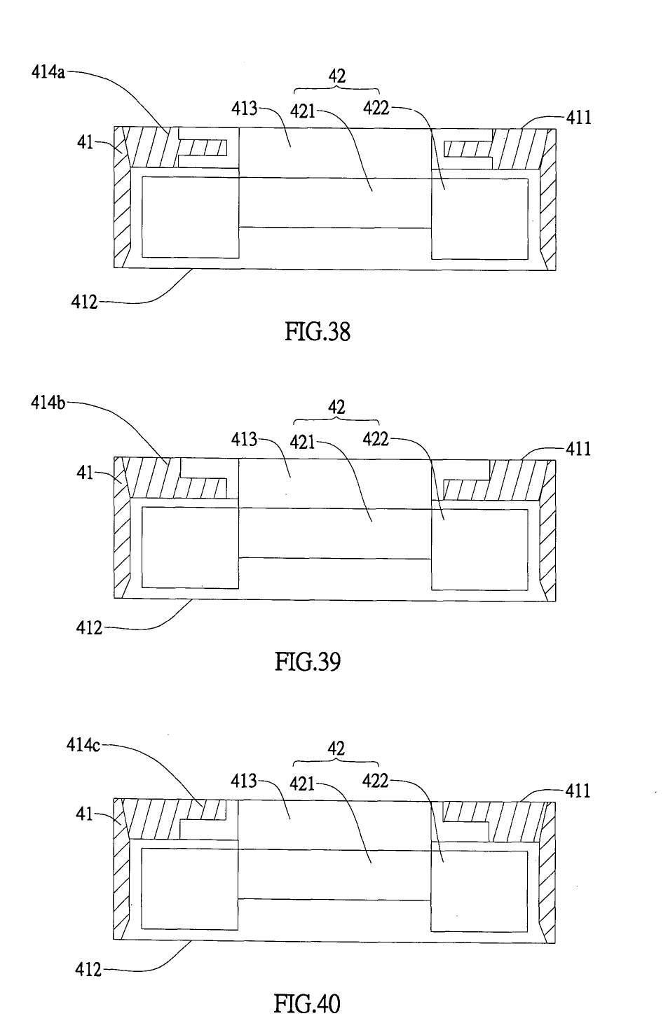

Please refer to FIGS. 37, 38, 39, and 40. The control blade 414 for the present invention may be differently configured, such as T-shaped, reverse L-shaped, and L-shaped control blade 414a, 414b, and 414c, as shown in FIGS. 38, 39, and 40, respectively. All the above three types of control blades are adapted to change the radial pressure against the fluid passing through the outlet 412 to achieve the effect of controlling the flow direction of the fluid.

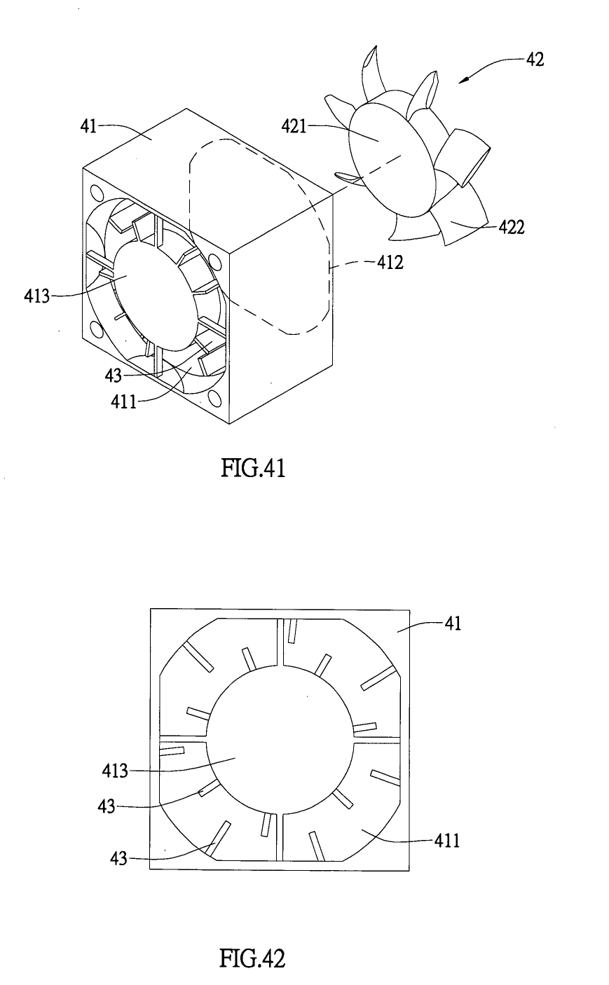

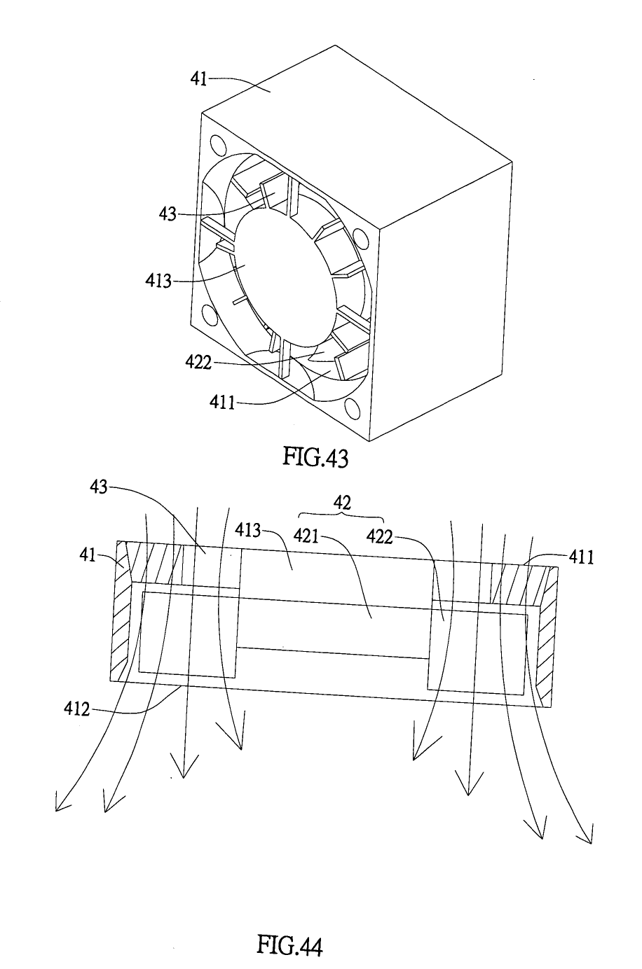

Please now refer to FIGS. 41, 42, 43, and 44, in which an outlet airflow direction control device according to an eighth embodiment of the present invention is shown. As shown, the eighth embodiment is structurally and functionally similar to the seventh embodiment, except that both the inlet 411 of the frame 41 and the hub seat 413 at the inlet 411 of the frame 41 of the eighth embodiment are formed on respective peripheral wall with a plurality of radially projected ribs 43 to change the radial pressure against the fluid flowing through the frame 41 and thereby control the flow direction of the fluid.

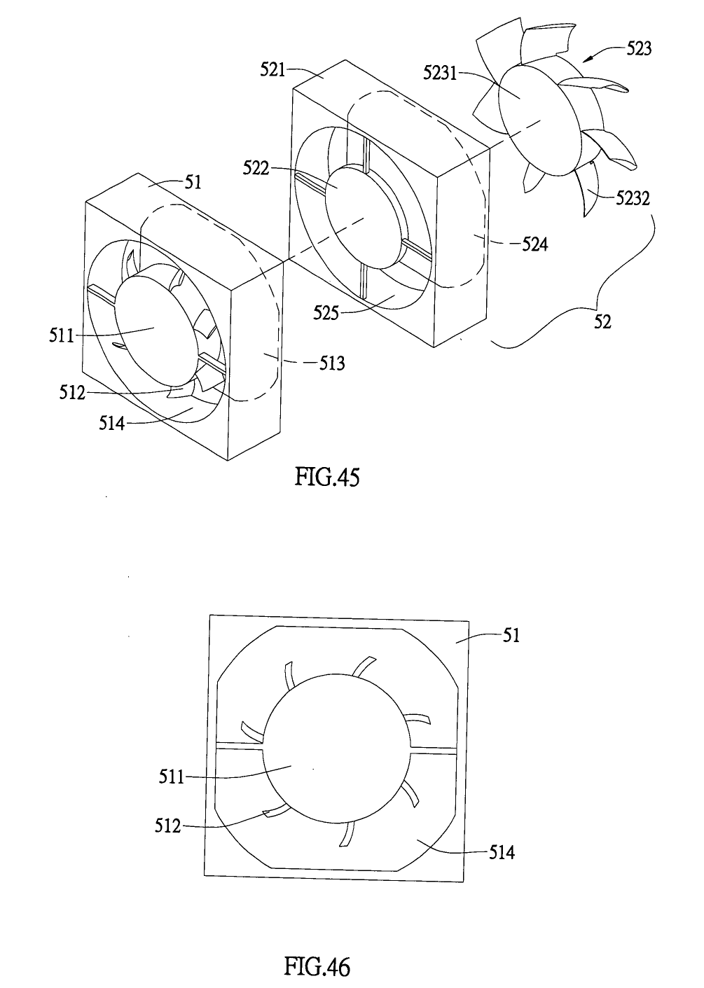

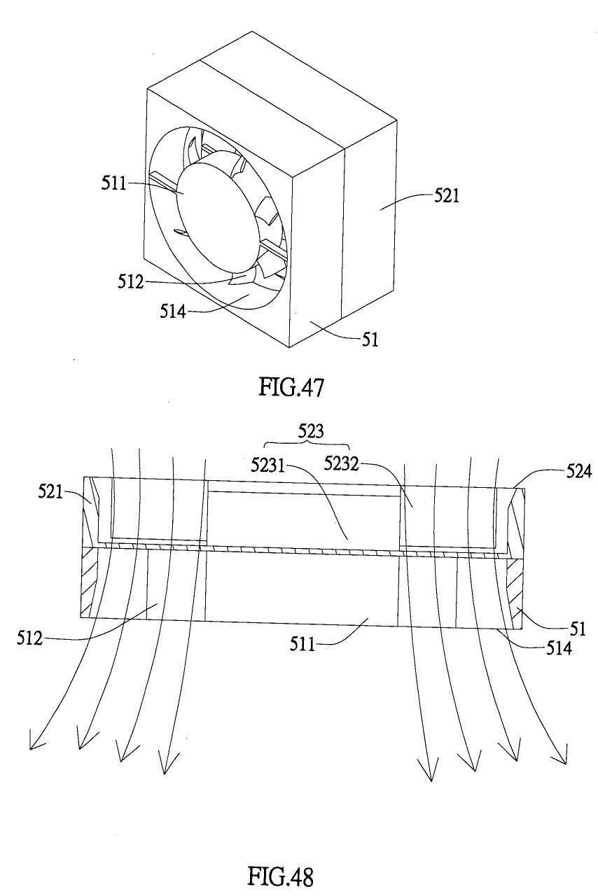

Please refer to FIGS. 45, 46, and 47, in which an outlet airflow direction control device according to a ninth embodiment of the present invention is shown. As shown, the ninth embodiment includes a frame 51 and a fan assembly 52. The frame 51 includes an inlet 513 and an outlet 514. The frame 51 is internally provided with a hub seat 511, on an outer peripheral wall of which a plurality of radially projected control blades 512 are formed. The frame 51 is connected at the inlet 513 to an outlet 525 of the fan assembly 52 to change a radial pressure against the fluid flowing through the fan assembly 52, and thereby control the flow direction of the fluid.

The fan assembly 52 includes a fan frame 521 and a fan 523. The fan frame 521 includes an inlet 524 and an outlet 525 via which an amount of fluid flows into and out of the fan frame 521, and is internally provided with a support member 522. The fan 523 consists of a hub 5231 and a plurality of blades 5232. The hub 5231 is supported on the support member 522 to locate the fan 523 in the fan frame 521.

Please refer to FIGS. 45 and 48. When the blades 5232 of the fan 523 are rotated, a non-constant flow field is produced to cause the fluid to flow into the fan assembly 52 via the inlet 524 thereof, pass through the outlet 525 of the fan assembly 52 and the inlet 513 of the frame 51, and flow out of the frame 51 via the outlet 514 thereof. When the fluid flows through the frame 51, it is affected by the radially projected control blades 512 and is subject to a relatively large radial pressure to therefore diffuse into surrounding space outside the outlet 514 of the frame 51. Since the fluid is subject to an increased radial pressure, it diffuses into an even increased space.

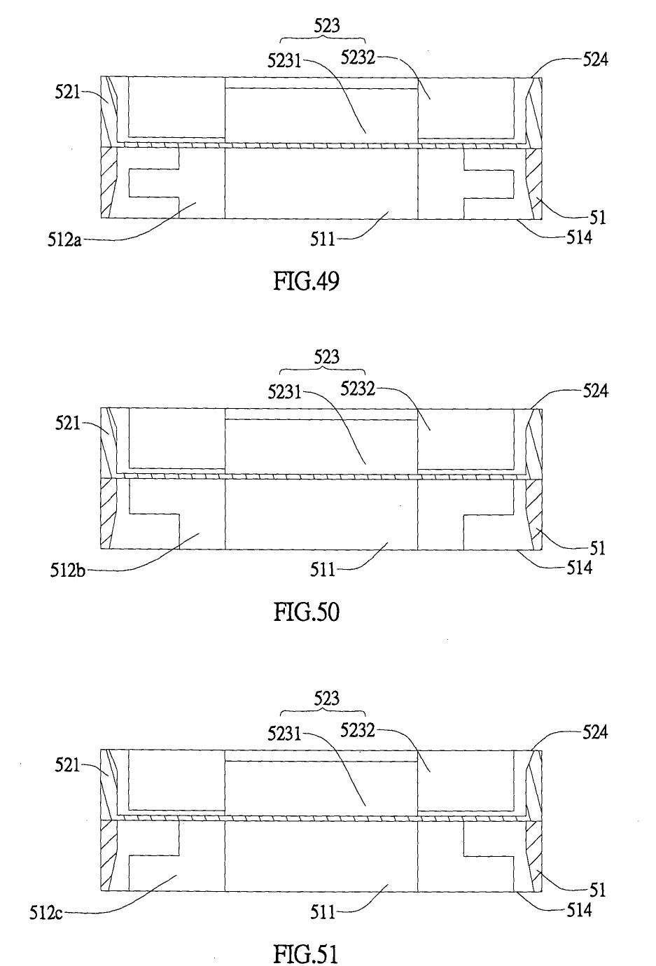

Please refer to FIGS. 48, 49, 50, and 51. The control blade 512 for the present invention may be differently configured, such as T-shaped, reverse L-shaped, and L-shaped control blade 512a, 512b, 512c, as shown in FIGS. 49, 50, and 51, respectively. All the above three types of control blades are adapted to change the radial pressure against the fluid passing through the outlet 514 to achieve the effect of controlling the flow direction of the fluid.

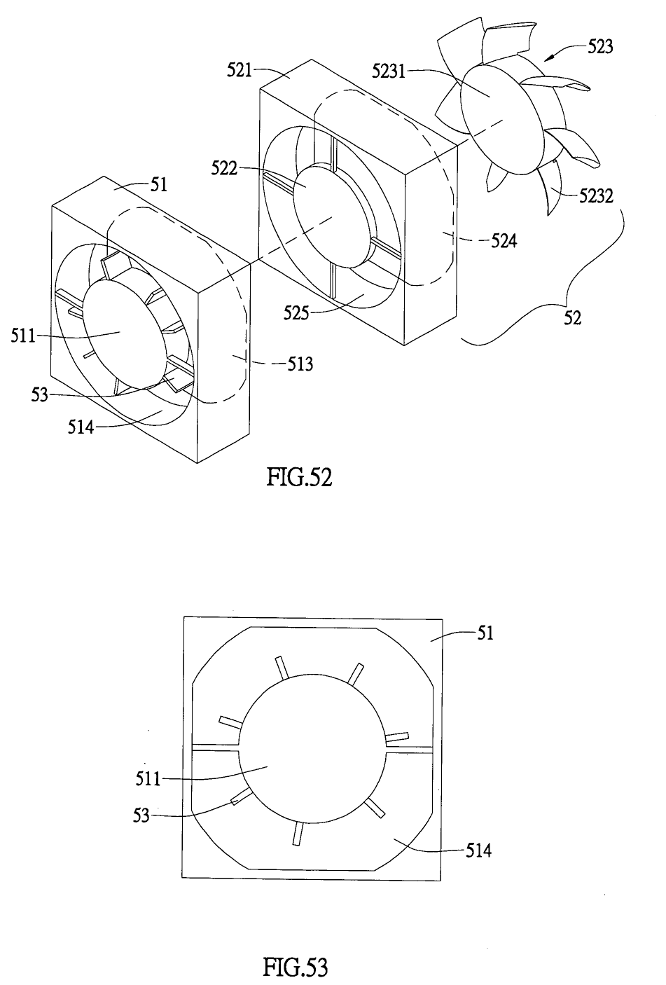

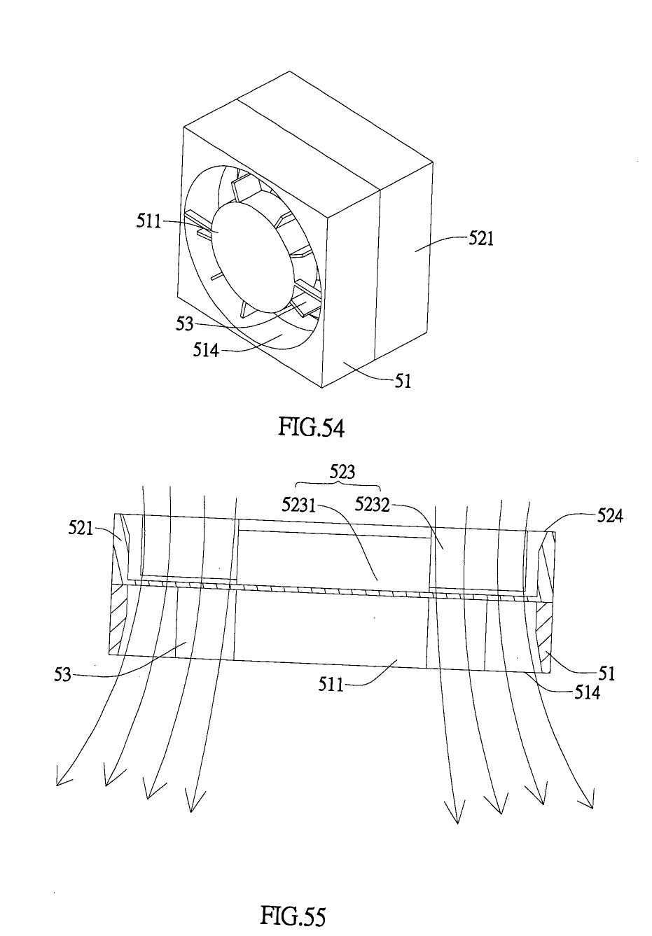

Please now refer to FIGS. 52, 53, 54, and 55, in which an outlet airflow direction control device according to a tenth embodiment of the present invention is shown. As shown, the tenth embodiment is structurally and functionally similar to the ninth embodiment, except that the hub seat 511 on the frame 51 of the tenth embodiment is formed on an outer peripheral wall with a plurality of radially projected ribs 53 to change the radial pressure against the fluid flowing through the frame 51 and the fan assembly 52, and thereby control the flow direction of the fluid to provide an enhanced radiating power.

Alternatively, the frame 51 for the ninth and the tenth embodiment of the present invention may be otherwise connected to the inlet 524 of the fan assembly 52 to achieve the same functions of controlling the flow direction of the fluid and providing an enhanced radiating power.

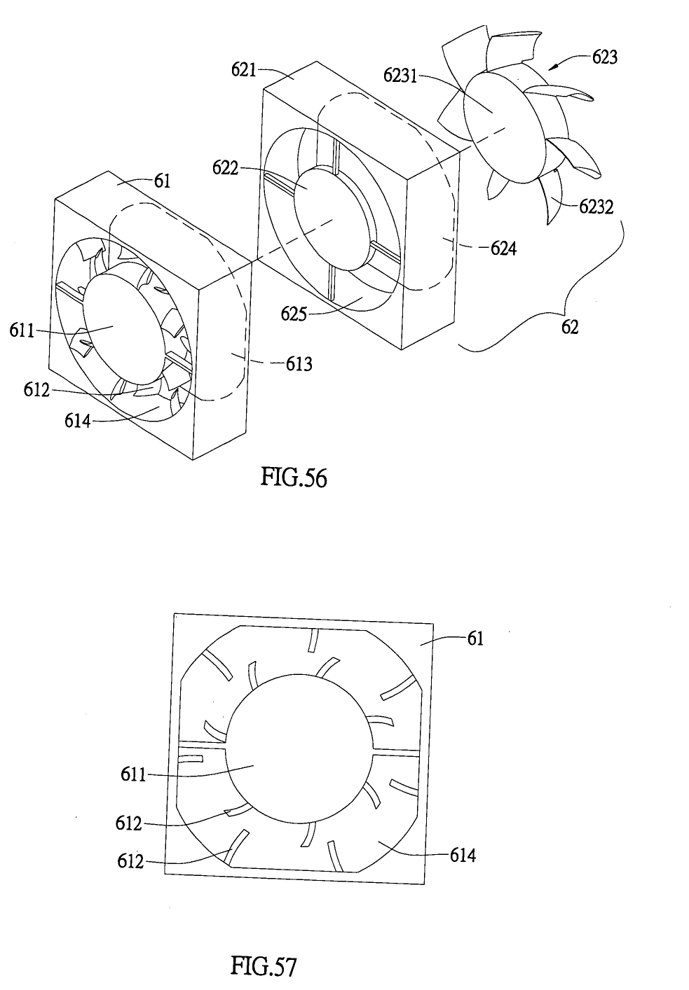

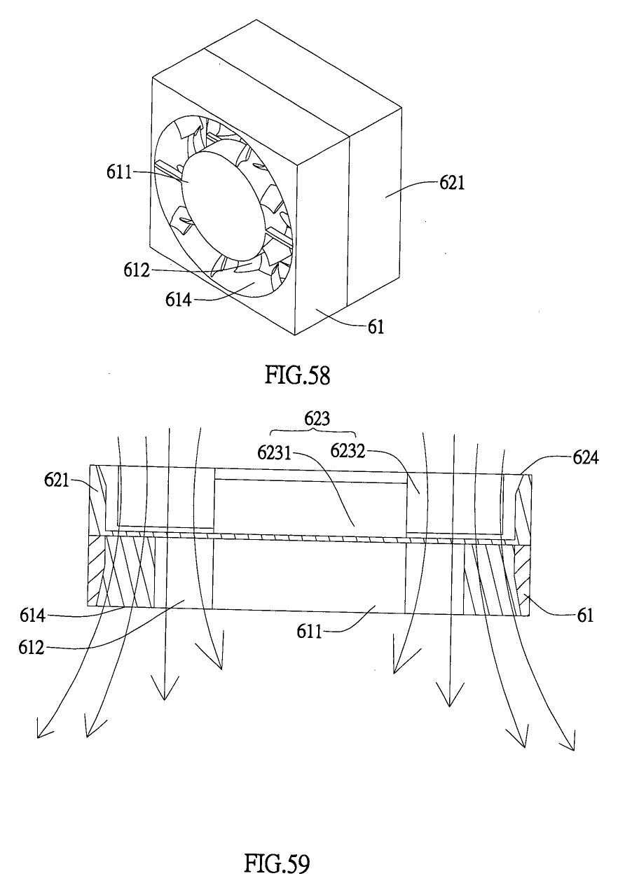

Please refer to FIGS. 56, 57, and 58, in which an outlet airflow direction control device according to an eleventh embodiment of the present invention is shown. As shown, the eleventh embodiment includes a frame 61 and a fan assembly 62. The frame 61 includes an inlet 613 and an outlet 614. The frame 61 is internally provided with a hub seat 611. Both the frame 61 and the hub seat 611 are provided on respective peripheral wall with a plurality of radially projected control blades 612. The frame 61 is connected at the inlet 613, to an outlet 625 of the fan assembly 62 to change a radial pressure against the fluid flowing through the fan assembly 62, and thereby control the flow direction of the fluid.

The fan assembly 62 includes a fan frame 621, a support member 622, and a fan 623. The fan frame 621 includes an inlet 624 and an outlet 625 via which an amount of fluid flows into and out of the fan frame 621. The support member 622 is internally provided on the fan frame 621. The fan 623 consists of a hub 6231 and a plurality of blades 6232. The hub 6231 is supported on the support member 622 to locate the fan 623 in the fan frame 621.

Please refer to FIGS. 56 and 59. When the blades 6232 of the fan 623 are rotated, a non-constant flow field is produced to cause the fluid to flow into the fan assembly 62 via the inlet 624 thereof, pass through the outlet 625 of the fan assembly 62 and the inlet 613 of the frame 61, and flow out of the frame 61 via the outlet 614 thereof. When the fluid flows through the frame 61, it is affected by the radially projected control blades 612 and is subject to a relatively large radial pressure. Therefore, the fluid flows toward a central area behind the hub seat 611 of the frame 61 and diffuses into surrounding space when it flows through the outlet 614 of the frame 61. And, since the fluid flows to the back of the hub seat 611, a dead-air zone behind the hub seat 611 is reduced. Therefore, when the outlet airflow direction control device according to the eleventh embodiment of the present invention is used to carry heat produced in a system to external environments, it provides largely upgraded radiation efficiency to achieve an enhanced overall radiation effect.

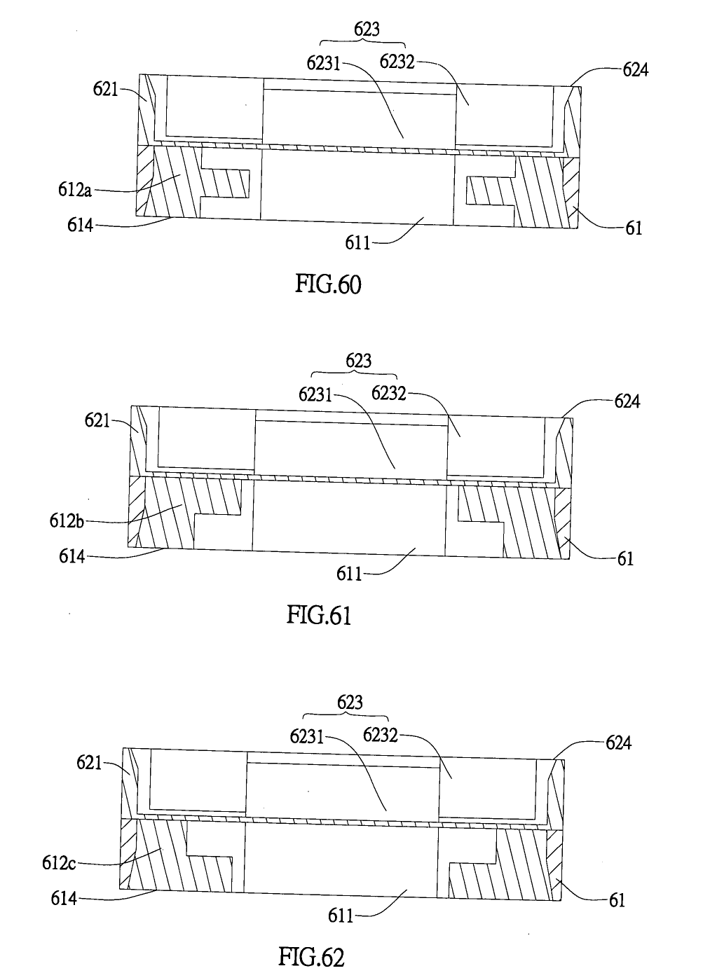

Please refer to FIGS. 59, 60, 61, and 62. The control blade 612 for the present invention may be differently configured, such as T-shaped, reverse L-shaped, and L-shaped control blade 612a, 612b, 612c, as shown in FIGS. 60, 61, and 62, respectively. All the above three types of control blades are adapted to change the radial pressure against the fluid passing through the outlet 614 to achieve the effect of controlling the flow direction of the fluid and increasing the radiating power.

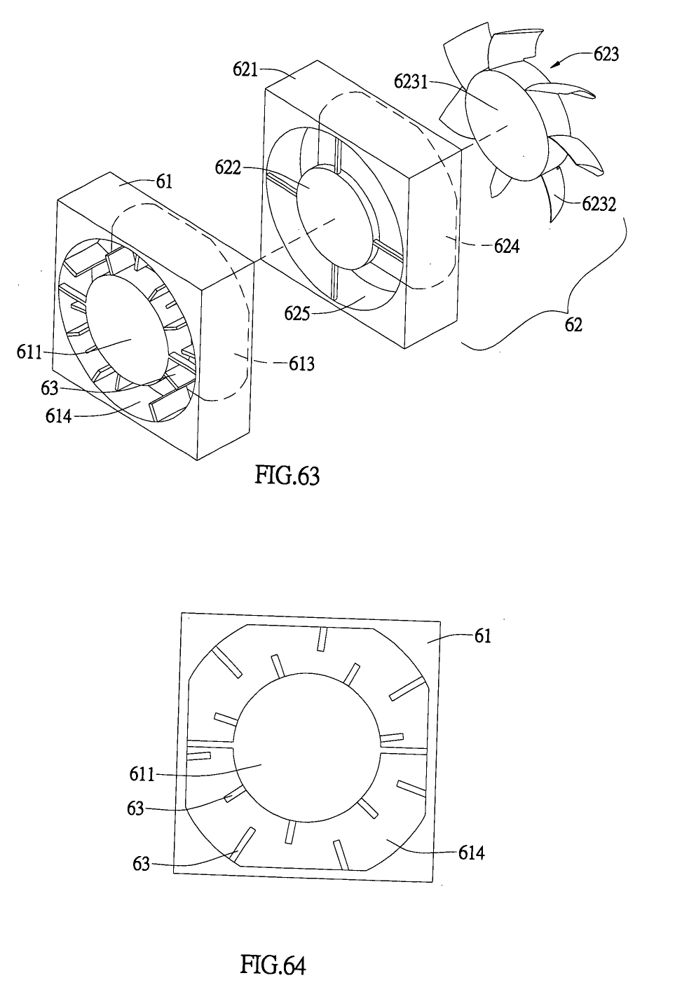

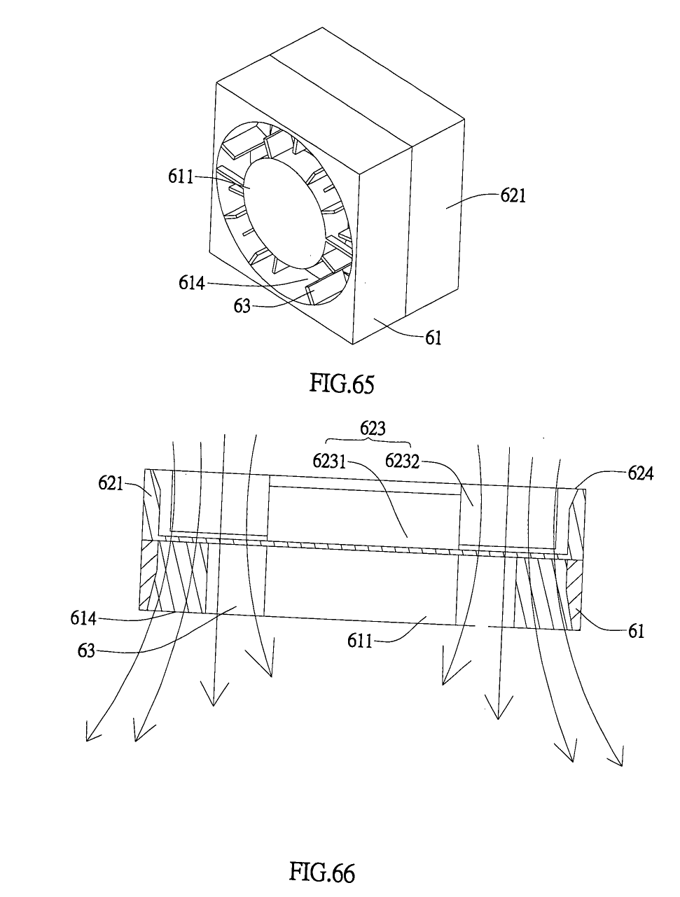

Please now refer to FIGS. 63, 64, 65, and 66, in which an outlet airflow direction control device according to a twelfth embodiment of the present invention is shown. As shown, the twelfth embodiment is structurally and functionally similar to the eleventh embodiment, except that both the frame 61 and the hub seat 611 on the frame 61 of the twelfth embodiment are formed on respective peripheral wall with a plurality of radially projected ribs 63 to change the radial pressure against the fluid flowing through the frame 61 and the fan assembly 62, and thereby control the flow direction of the fluid.

Alternatively, the frame 61 for the eleventh and the twelfth embodiment of the present invention may be otherwise connected to the inlet 624 of the fan assembly 62 to achieve the same functions of controlling the flow direction of the fluid and providing an enhanced radiating power.

The present invention has been described with some preferred embodiments thereof and it is understood that many changes and modifications in the described embodiments can be carried out without departing from the scope and the spirit of the invention as defined by the appended claims.

1. An outlet airflow direction control device, comprising a frame and a fan;
said frame having an inlet and an outlet and being internally provided at said outlet with a hub seat, said hub seat at said outlet being provided on a peripheral wall with a plurality of radially projected fluid control elements; and
said fan being supported on said hub seat of said frame;
whereby when said fan is rotated to cause an amount of fluid to flow into and out of said frame via said inlet and said outlet, respectively, said fluid control elements are adapted to control a flow direction of said fluid flown out of said outlet of said frame.

2. The outlet airflow direction control device as claimed in claim 1, wherein said fluid control elements are control blades.

3. The outlet airflow direction control device as claimed in claim 1, wherein said fluid control elements are ribs.

4. An outlet airflow direction control device, comprising a frame and a fan;
said frame having an inlet and an outlet and being internally provided at said outlet with a hub seat; both said frame and said hub seat at said outlet being provided on respective peripheral wall with a plurality of radially projected fluid control elements; and
said fan being supported on said hub seat of said frame;
whereby when said fan is rotated to cause an amount of fluid to flow into and out of said frame via said inlet and said outlet, respectively, said fluid control elements are adapted to control a flow direction of said fluid flown out of said outlet of said frame.

5. The outlet airflow direction control device as claimed in claim 4, wherein said fluid control elements are control blades.

6. The outlet airflow direction control device as claimed in claim 4, wherein said fluid control elements are ribs.

7. An outlet airflow direction control device, comprising a frame and a fan;
said frame having an inlet and an outlet and being internally provided at said inlet with a hub seat, said hub seat at said inlet being provided on a peripheral wall with a plurality of radially projected fluid control elements; and
said fan being supported on said hub seat of said frame;
whereby when said fan is rotated to cause an amount of fluid to flow into and out of said frame via said inlet and said outlet, respectively, said fluid control elements are adapted to control a flow direction of said fluid flown out of said outlet of said frame.

8. The outlet airflow direction control device as claimed in claim 7, wherein said fluid control elements are control blades.

9. The outlet airflow direction control device as claimed in claim 7, wherein said fluid control elements are ribs.

10. An outlet airflow direction control device, comprising a frame and a fan;
said frame having an inlet and an outlet and being internally provided at said inlet with a hub seat; both said frame and said hub seat at said inlet being provided on respective peripheral wall with a plurality of radially projected fluid control elements; and
said fan being supported on said hub seat of said frame;
whereby when said fan is rotated to cause an amount of fluid to flow into and out of said frame via said inlet and said outlet, respectively, said fluid control elements are adapted to control a flow direction of said fluid flown out of said outlet of said frame.

11. The outlet airflow direction control device as claimed in claim 10, wherein said fluid control elements are control blades.

12. The outlet airflow direction control device as claimed in claim 10, wherein said fluid control elements are ribs.

13. An outlet airflow direction control device, comprising a frame connected to a fan assembly; said frame being internally provided with a hub seat, on a peripheral wall of which a plurality of radially projected fluid control elements are provided to control a flow direction of an amount of fluid flown through said frame.

14. The outlet airflow direction control device as claimed in claim 13, wherein fan assembly includes a fan frame and a fan.

15. The outlet airflow direction control device as claimed in claim 13, wherein said fluid control elements are control blades.

16. The outlet airflow direction control device as claimed in claim 13, wherein said fluid control elements are ribs.

17. An outlet airflow direction control device, comprising a frame connected to a fan assembly; said frame being internally provided with a hub seat, and both said frame and said hub seat being provided on respective peripheral wall with a plurality of radially projected fluid control elements to control a flow direction of an amount of fluid flown through said frame.

18. The outlet airflow direction control device as claimed in claim 17, wherein fan assembly includes a fan frame and a fan.

19. The outlet airflow direction control device as claimed in claim 17, wherein said fluid control elements are control blades.

20. The outlet airflow direction control device as claimed in claim 17, wherein said fluid control elements are ribs.
